(19) United States
(12) Patent Application Publication
(10) Pub. No.: US 2003/0009855 A1
(43) Pub. Date: Jan. 16, 2003

(54) Outside door handle arrangement

(75) Inventor: Edgar Budzynski, Dortmund (DE)

Correspondence Address: NIXON PEABODY, LLP, 8180 GREENSBORO DRIVE, SUITE 800, MCLEAN, VA, 22102, US

(73) Assignee: Robert Bosch GmbH, Stuttgart (DE)

(21) Appl. No.: 10/166,029

(22) Filed: Jun. 11, 2002

Related U.S. Application Data
(63) Continuation-in-part of application No. 10/058,239, filed on Jan. 29, 2002, now abandoned.

(30) Foreign Application Priority Data
Jun. 12, 2001 (DE) 101 32 925.3
Jun. 12, 2001 (DE) 101 28 317.2

(51) Int. Cl. B62B 1/00

(52) U.S. Cl. 16/443

(57) ABSTRACT

An outside door handle arrangement including an electronic sensor for detecting actuation of an outside door handle of a motor vehicle. An electronic circuit, which is assigned to the electronic sensor, is located directly on a piezoelement such that the piezoelement is used as a circuit carrier. Additionally, the piezoelement is used for holding an assigned electronic circuit such that the electronic circuit is mounted on and is electronically connected to the piezoelement.

### BACKGROUND OF THE INVENTION

1. Field of the Invention

This invention relates to an outside door handle arrangement for a motor vehicle door locking system and the use of a piezoelement.

2. Field of the Invention

Published European application 1 103 432 discloses an outside door handle arrangement in which a piezoelement is installed as a sensor element in an at least essentially rigid outside door handle. The piezoelement is connected to an assigned electronic circuit by means of a separate line.

Published PCT application WO 99/28170 discloses an outside door handle arrangement in which a strip-shaped piezoelement is installed as a sensor element in an outside door handle. The piezoelement is located on a swiveling carrier and is connected by separate lines to an assigned electronic circuit.

In the aforementioned prior art, the construction cost, installation cost, and space requirement for the sensor element and the assigned circuit are considerable.

### SUMMARY OF THE INVENTION

The primary object of this invention is to provide an outside door handle arrangement including a piezoelement as a sensor element such that the outside door handle arrangement has a an integrated piezoelement after an economical installation.

The aforementioned object is achieved by an outside door handle arrangement for a vehicle door locking system including a piezoelement for detecting the actuation of the outside door handle and an electronic circuit mounted directly on and electrically connected to the piezoelement.

The aforementioned object is further achieved by the use of a piezoelement for holding an assigned electronic circuit such that the electronic circuit is mounted directly on and electrically connected to the piezoelement.

According to the present invention, the electronic circuit assigned to the piezoelement is positioned directly on the piezoelement. Therefore, the piezoelement is used as a circuit carrier or component carrier for the circuit. This idea has to several advantages over the prior art.

Another object of the present invention is provide an outside door handle arrangement including a piezoelement as a sensor element such that arrangement has a compact structure. This object is achieved by minimizing the space requirement for the piezoelement as a sensor element and the assigned circuit such that the size of the outside door handle into which the piezoelement is integrated is also minimized.

Another object of the present invention is to provide an outside door handle arrangement including a piezoelement as a sensor element such that the installation cost is minimized. This object is achieved by installing or integrating the piezoelement and the assigned circuit as an installation unit into the outside door handle arrangement instead having a separate connection of the piezoelement to the assigned circuit.

Furthermore, a separate connecting line between the piezoelement and the assigned circuit is eliminated, enabling improvement of the signal quality or noise voltage interval because the signals originating from the piezoelement can be amplified or further processed and evaluated directly by the circuit.

Additionally, by eliminating the separate connecting line between the piezoelement and the assigned circuit, the risk that noise signals will be coupled and override or interfere with the signals of the piezoelement is minimized.

Also, by eliminating the separate connecting line between the piezoelement and the assigned circuit, the operating reliability is increased because the number of required connections or contact points can be minimized.

It has been shown that even with the conventional flexibility or deformability of the piezoelement, the circuit can be located at least partially on the surface of the piezoelement and remain reliable in operation.

Other aspects, properties, features and advantages of this invention arise from the following explanation of preferred embodiments which are shown in the drawings.

### BRIEF DESCRIPTION OF THE DRAWINGS

FIG. 1 shows a schematic perspective view of a motor vehicle with a motor vehicle door locking system;

FIG. 2 shows an outside door handle arrangement of the motor vehicle door locking system as shown in FIG. 1;

FIG. 3 shows a schematic cross section of the outside door handle arrangement in accordance with the invention;

FIG. 4 shows a schematic of a piezoelement with a circuit located on it according to the first embodiment; and

FIG. 5 shows a schematic of a piezoelement with a circuit located on it according to a second embodiment.

### DETAILED DESCRIPTION OF THE INVENTION

The same reference numbers are used for the same or similar parts, and the corresponding or comparable advantages and properties arise, even if a repeated description is omitted.

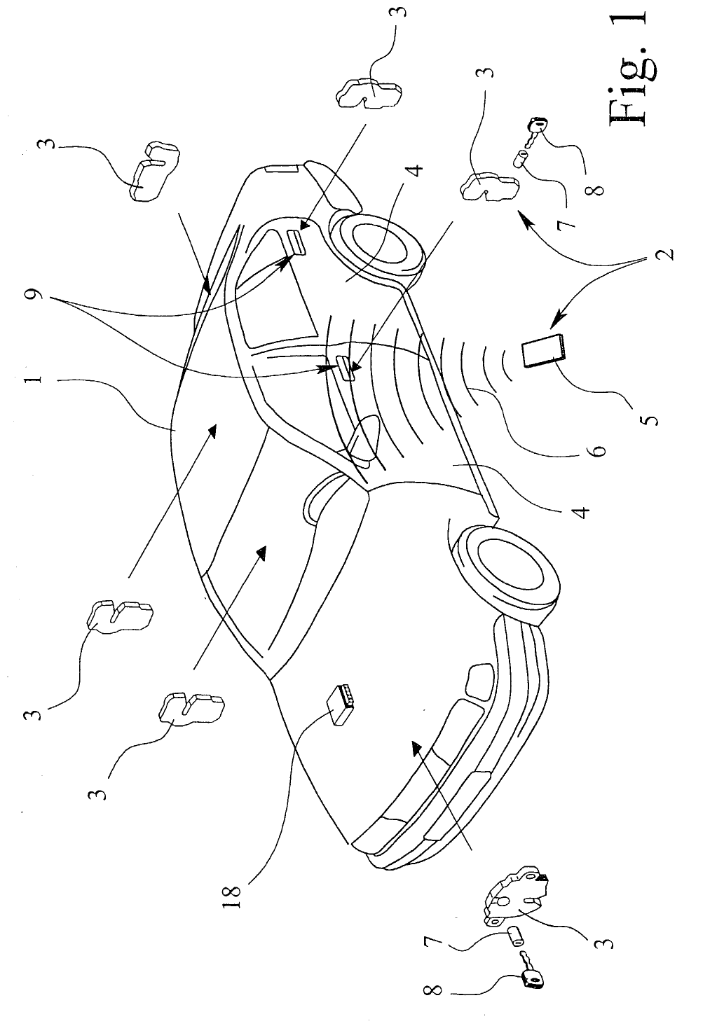

FIG. 1 schematically shows a motor vehicle 1 with a motor vehicle door locking system 2 of the present invention. The motor vehicle door locking system 2 has several vehicle locks 3 for the vehicle doors 4, the rear hatch, and the hood, with installation positions which are shown schematically in FIG. 1.

Each motor vehicle lock 3 can be locked and unlocked by a motor, such as an electric motor, by means of a known central interlock system or a central interlock drive. In the case of an electric lock provided in the motor vehicle locks 3 of the vehicle side doors 4, each motor vehicle lock 3 has the possibility of a motorized opening by lifting the detent pawl (not shown) by an opening drive (not shown). Locking and unlocking can also be accomplished by only using circuitry.

The motor vehicle door locking system 2 is preferably equipped with a “passive entry” function, which is defined as automatic, vehicle-side data interrogation or identification of an operator-side data medium, such as a transponder 5, by signal waves 6, in order to ascertain whether an operator approaching the motor vehicle 1 or an operator about to open the vehicle door 4 is authorized for access. Whether access is authorized is generally determined by the corresponding electronics of the motor vehicle 1. With the corresponding authorization of the operator, automatic unlocking occurs for either a central interlock system, the lock 3 of the driver-side door 4, the lock 3 of the door 4 being approached by the operator, or the outside door handle the operator is touching or activating.

A locking cylinder 7 for actuation with a mechanical key 8 can be assigned to the motor vehicle lock 3 of the driver-side door and the hood lock. Therefore, the vehicle door lock 3 of the driver-side door can be mechanically actuated or unlocked in an emergency with the key 8 and opened. Similarly, there can be emergency unlocking or opening for the vehicle door locks 3 of the other doors 4 if desired.

Furthermore, as shown in FIG. 1, an outside door handle arrangement 9 is assigned to at least each motor vehicle door lock 3 of the motor vehicle side doors 4.

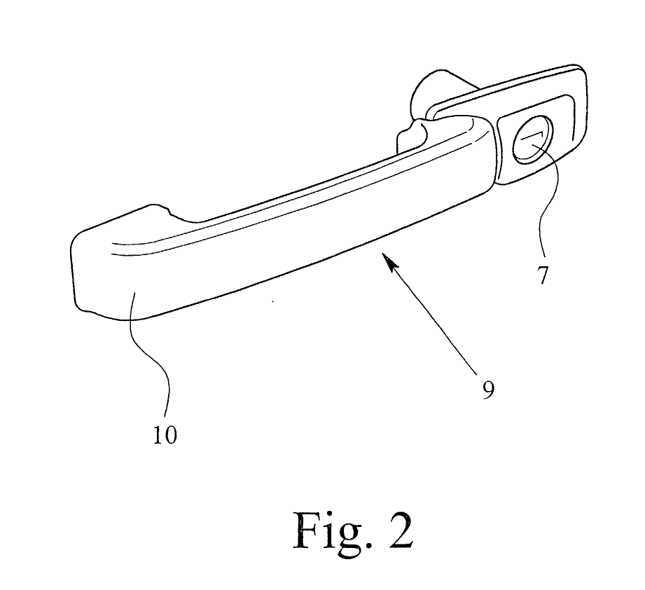

FIG. 2 shows the outside door handle arrangement 9 of the driver's door with an integrated locking cylinder 7. If desired, the locking cylinder 7 can be omitted.

Furthermore, the outside door handle arrangement 9 includes an outside door handle 10 which is stationary and which has no moving parts, such as a movable actuating and opening lever. A bow-shaped handle is shown, but a flap handle can also be used as an alternative.

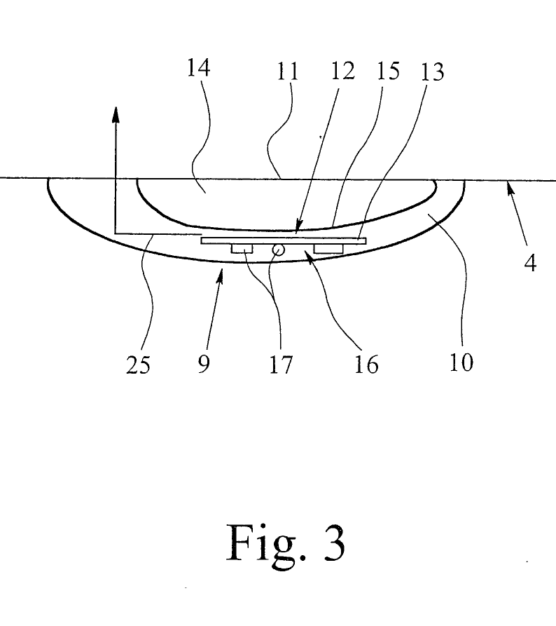

FIG. 3 shows the outside door handle arrangement 9 with the adjacent door area 11. The outside door handle arrangement 9 together with this adjacent door area 11 can be inserted as a unit into the assigned motor vehicle door 4. However, this is not absolutely necessary because there can be a stationary outside door handle 10.

Furthermore, FIG. 3 shows the outside door handle arrangement 9 without the locking cylinder 7. In this embodiment, a sensor 12 is assigned to the outside door handle 10. The sensor 12 has a deforrnation-sensitive, force-sensitive and/or pressure-sensitive sensor element in the form of a piezoelement 13.

The piezoelement 13 is preferably a piezocrystal which produces an electrical voltage upon loading or deformation by crystal deformation, especially on its sides perpendicular to the direction of deformation. This voltage is then tapped with high-resistance, amplified and evaluated. Additionally, resistive evaluation and/or optionally capacitive evaluation of the signals or characteristics of the piezoelement 13 can take place for detection of the loading or deformation of the piezoelement 13.

The outside door handle 10 defines an engagement space 14 for the hand of the operator, which is not shown. The “engagement space” here is accordingly defined as the space into which the hand of an operator which is not shown ordinarily fits to actuate the outside door handle 10.

The piezoelement 13 can, for example, be located on the inside wall or the inner side 15 of the outside door handle 10 facing the engagement space 14 and can cover the inner side 15 and/or the adjoining areas of the outside door handle 10 over a large area, preferably completely. Additionally, the piezoelement 13 can be integrated within the outside door handle 10, such as located or potted in a cavity.

The outside door handle 10 is preferably made at least partially elastically deformable. The sensor 12 can detect deformation of the outside door handle 10 which is caused by actuation, so that actuation can be detected.

Evaluation electronics or an electronic circuit 16 with at least one electrical component such as an IC (integrated circuit) is assigned to the piezoelement 13. The circuit 16 is at least partially integrated into the outside door handle arrangement 9 or the outside door handle 10.

Additionally, evaluation can take place partially in an assigned motor vehicle door 4 or central motor vehicle electronics or control electronics 18 of the motor vehicle 1 which is shown in FIG. 1.

When the hand of an operator which is not shown grasps and loads or deforms (actuates) the outside door handle 10, this leads to a corresponding change of the measurement signals and/or characteristics of the sensor 12 or the sensor element 13 which can be evaluated as contact and/or actuation of the outside door handle 10. In particular, a corresponding signal is output from the evaluation electronics 16, for example, to the central motor vehicle electronics 18. Accordingly, a central interlock of the assigned motor vehicle door lock 3 can be unlocked or the assigned motor vehicle door lock 3 can be opened.

One important aspect of the outside door handle arrangement 9 in the present invention is that the circuit 16 is formed or located directly on the piezoelement 13. The piezoelement 13 therefore bears the circuit 16 and at least some of the all electronic components 17 of the circuit 16. The piezoelement 13 is therefore used as a circuit or component carrier.

The piezoelement 13 is directly connected electrically to the circuit 16 so that preferably separate connecting lines or cabling to connect the piezoelement 13 to the circuit 16 are not necessary.

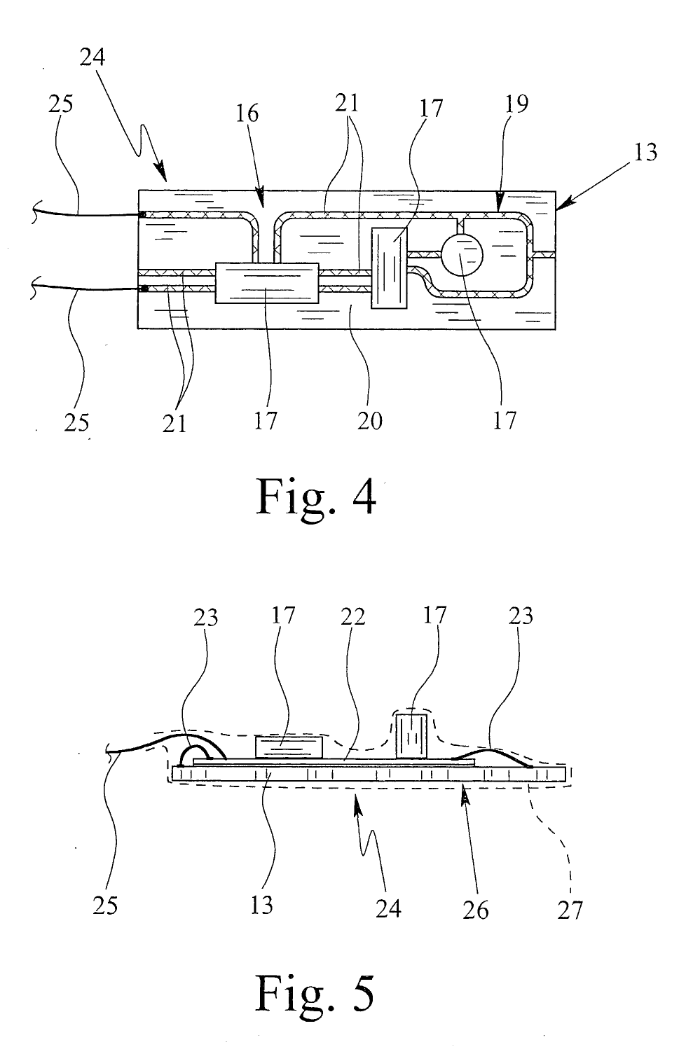

According to the first embodiment shown in FIG. 4, the conductor arrangement 19 of the circuit 16 is formed directly on at least one side or surface 20 of the piezoelement 13. The piezoelement 13 has at least one ceramic layer (monomorphous structure) which can be metal coated, for example, by screen printing, sputtering, or vacuum metallization. This metal coating can then directly form the conductor arrangement 19 with the corresponding printed conductors 21 or can be used for their manufacture, for example, by etching or laser removal.

The individual components 17 of the circuit 16 are preferably applied directly to the conductor arrangement 19, such as cemented on, and are therefore connected to the corresponding printed conductors 21. The conductor arrangement 19 preferably also establishes the electrical connection to the piezoelement 13 simultaneously.

Depending on the requirement, the circuit 16 of course can also be located on several sides 20 of the piezoelement 13, especially on opposing flat sides. The corresponding of course applies to the direct application of the conductor arrangement 19 to the piezoelement 13.

In the already explained direct application of the conductor arrangement 19 to the ceramic layer of the piezoelement 13, a monomorphous structure was assumed. Similarly, this is also possible in other built-on accessories, for example, bi-layer (bimorphous) or tri-layer (trimorphous) built-on accessories or ceramics.

Furthermore, the conductor arrangement 19 can also be applied directly or indirectly, for example via an adhesive layer and/or electrically insulating layer, to other layers or surfaces as ceramic layers.

The metal coating or conductor arrangement 19 which has been formed directly on the piezoelement 13 can also be used for monitoring of the piezoelement 13 for serviceability or fracture. For example, this can take place by monitoring whether the metal coating or conductor arrangement 19 has been interrupted or whether this changes its resistance or other electrical properties.

Instead of the piezoelement 13, another sensor element can be used on which the circuit 16 can be located and carried thereby. In particular, the sensor element is a component which has been formed at least in part from ceramic material and/or a sensor element which converts a mechanical quantity, such as load or deformation, directly into an electrical quantity or change of magnitude.

FIG. 5 shows a schematic side view of the piezoelement 13 with the circuit 16 according to a second embodiment. In this embodiment, the conductor arrangement 19 is not formed directly on the piezoelement 13, but is applied in the form of a flexible conductor foil or circuit board 22 to the piezoelement 13. The circuit board 22 therefore forms the conductor arrangement 19 and is cemented onto the piezoelement 13 or mechanically joined to it in some other suitable manner.

Depending on the configuration of the connection and the circuit board 22, an electrical connection of the circuit 16 formed on the circuit board 22 and of the piezoelement 13 can be formed simultaneously.

If necessary, however, there can also be separate lines or cables 23, as indicated in FIG. 5, for electrical connection of the piezoelement 13 to the circuit 16. For example, the cables can be soldered on.

Additionally, there can also be direct contact-making between the circuit board 22, the conductor arrangement 19 formed on it, and the piezoelement 13 by soldering, using a suitable conductive cement, or in some other suitable manner.

The piezoelement 13 and the circuit 16 in the above described embodiments form an installation unit 24 which is prefabricated and then, together with at least one connecting line 25 which has been connected to the circuit 16 for example, by soldering or cementing, installed in the outside door handle arrangement 9. For example, the installation unit 24 is installed in a suitable recess or a suitable cavity in the outside door handle 10 and cemented, injected or attached or held in some other suitable manner if necessary.

The installation unit 24 can also be defined as a sensor 12, at least certain signal conditioning and/or signal evaluation taking place by the circuit 16 in the sensor 12. As already explained, more extensive signal conditioning and/or signal evaluation of course can take place subsequently, for example by the central motor vehicle electronics 18.

The circuit 16 and especially the conductor arrangement 19 or the circuit board 19 are matched to the piezoelement 13 and connected to it such that the flexibility or deformability of the piezoelement 13, which is necessary for detection of actuation of the outside door handle 10, is enabled and maintained. The installation unit 24 is accordingly installed in a suitable manner in the outside door handle 10 and/or is connected to it or supported or held by it.

For example, the piezoelement 13 can be located in the manner of a carrier in a cavity of the outside door handle 10 which is not shown, deformation of the outside door handle 10 for example leading to at least essentially only spot or local loading of the piezoelement 13.

The piezoelement 13 can also be located on some other or additional carrier (not shown) if necessary and which forms a component of the installation unit 24.

According to FIG. 5, the installation unit 24 is surrounded by a cladding 26. The cladding 26 is preferably made watertight and water vapor tight. The cladding 26 forms mechanical protection or protection against corrosion. The cladding 26 can also be used for electrical insulation. These protective functions can be especially important when the installation unit 24 is potted into the outside door handle 10 or is inserted into a recess of the outside door handle 19 which can be open to the outside.

The cladding 26 surrounds the installation unit 24 preferably watertight at least essentially on all sides, and the cladding 26 of the installation unit 24 allows the flexibility which is necessary for installation and later operation.

The cladding 26 preferably has a jacket 27 of a suitable rubber or plastic material that is relatively watertight and also gas tight.

In particular, the jacket 27 is made film-like and/or is shrunk onto the installation unit 24.

In another embodiment, the installation unit 24 can encompass a desiccant s held by the cladding 26 or the jacket 27.

Additionally, cavities in the jacket 27 between the components 17 and other components can be filled, for example foamed or sprayed, with a suitable material, after installation of the installation unit 24 in the outside door handle 10.

We claim:

1. An outside door handle arrangement for a motor vehicle door locking system comprising:
an outside door handle for opening an assigned motor vehicle door lock;
a piezoelement which is assigned to the outside door handle for detecting actuation of the outside door handle by a hand of an operator; and
an electronic circuit which is assigned to the piezoelement;
wherein the electronic circuit is located on the piezoelement and is carried by it.

2. The outside door handle arrangement as claimed in claim 1, wherein the piezoelement is an electronic component.

3. The outside door handle arrangement as claimed in claim 1, wherein the piezoelement is a conductor arrangement.

4. The outside door handle arrangement as claimed in claim 1, wherein the piezoelement is a circuit board of the electronic circuit.

5. The outside door handle arrangement as claimed in claim 1, wherein the piezoelement has a metal coating.

6. The outside door handle arrangement as claimed in claim 1, wherein the piezoelement contains a ceramic surface.

7. The outside door handle arrangement as claimed in claim 6, wherein the ceramic surface of the piezoelement has a metal coating.

8. The outside door handle arrangement as claimed in claim 1, wherein the piezoelement is provided with a conductor arrangement of the electronic circuit.

9. The outside door handle arrangement as claimed in claim 5, wherein the metal coating is one of a printed on, vapor-deposited, and cemented on coating.

10. The outside door handle arrangement as claimed in claim 8, wherein the conductor arrangement is printed, vapor-deposited, or cemented onto the piezoelement.

11. The outside door handle arrangement as claimed in claim 1, wherein all components of the electronic circuit are carried by the piezoelement.

12. The outside door handle arrangement as claimed in claim 1, wherein at least one component of the electronic circuit is held on the piezoelement by cement.

13. The outside door handle arrangement as claimed in claim 1, wherein at least one component of the electronic circuit is attached with cement onto a conductor arrangement which is formed on the piezoelement.

14. The outside door handle arrangement as claimed in claim 1, wherein a flexible circuit board is cemented onto the piezoelement.

15. The outside door handle arrangement as claimed in claim 1, wherein the piezoelement with the electronic circuit forms an installation unit which is located on the outside door handle.

16. The outside door handle arrangement as claimed in claim 1, wherein the piezoelement with the electronic circuit forms an installation unit which is installed in the door handle.

17. The outside door handle arrangement as claimed in claim 1, wherein the outside door handle arrangement has at least one connecting line which is connected to the electronic circuit formed on the piezoelement.

18. The outside door handle arrangement as claimed in claim 1, wherein the outside door handle arrangement has at least one connecting line which is connected to the piezoelement.

19. The outside door handle arrangement as claimed in claim 1, wherein the piezoelement and the electronic circuit are surrounded by a watertight and water vapor-tight cladding.

20. The outside door handle arrangement as claimed in claim 1, wherein the piezoelement, the electronic circuit, and a section of the connecting line are surrounded by a watertight and water vapor-tight cladding.

21. The outside door handle arrangement as claimed in claim 19, wherein the cladding has a flexible jacket.

22. A method of using a piezoelement for holding an assigned electronic circuit, wherein the electronic circuit is mounted directly on and is electrically connected to the piezoelement.
